(19) United States
(12) Patent Application Publication
(10) Pub. No.: US 2010/0236347 A1
(43) Pub. Date: Sep. 23, 2010

(54) GEAR TRANSMISSION APPARATUS

(75) Inventors: Hiroki Kuwamoto, Shizuoka-ken (JP); Toshihiro Hirao, Shizuoka-ken (JP); Masato Terashima, Shizuoka-ken (JP); Akiyuki Suzuki, Aichi-ken (JP); Yusuke Nemoto, Shizuoka-ken (JP); Kazuya Fujita, Aichi-ken (JP); Akira Nakata, Shizuoka-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: TOYOTA JIDOSHA KABUSHIKI KAISHA, Toyota-shi, Aichi-ken (JP)

(21) Appl. No.: 12/664,958

(22) PCT Filed: Jun. 25, 2008
(86) PCT No.: PCT/JP2008/061581

§ 371 Date: May 5, 2010

(30) Foreign Application Priority Data
Jun. 26, 2007 (JP) 2007-167902

(51) Int. Cl. F16H 57/04

(52) U.S. Cl. 74/467

(57) ABSTRACT

In a gear transmission apparatus including a shared gear in which two rows of internal teeth are formed on an inner circumference of a common gear main body so as to be adjacent to each other in an axial direction, the internal teeth of each of the rows are meshed with an external gear to configure a transmission mechanism for each of the rows, the internal teeth of each of the rows are inclined with respect to the axial direction such that each of inner end portions thereof in the axial direction is further deviated to a normal rotation direction, which is a rotation direction in which a frequency in use of the shared gear is high, than each of outer end portions in the axial direction, oil drainage holes are provided between the internal teeth, and oil drainage grooves are provided on bottom lands of the internal teeth.

### TECHNICAL FIELD

The present invention relates to a gear transmission apparatus which shares an internal gear between the transmission mechanisms.

### BACKGROUND ART

As a gear transmission apparatus to transmit drive force of vehicles and the like, there is know a gear transmission apparatus which has a shared gear formed with two rows of internal teeth on an inner circumference of a common gear main body, and which has sun gears and carriers to be provided to the rows of the internal teeth on the inner side of the shared gear to thereby configure a pair of planetary gear mechanisms (for example, see non-patent document 1). Besides, there are Patent Documents 1 to 3 as prior art references in relation to the present invention.

Patent Document 1: JP-A1-2005-517139

Patent Document 2: JP-A-1998-184863

Patent Document 3: JP-A-1995-980651

Non-Patent Document 1: “New Car Practical Guide Book of Harrier Hybrid” chapter 3, page 26, edited and issued on 22.3 2005 by Toyota Motor Corporation.

### DISCLOSURE OF THE INVENTION

### Problems to be Solved by the Invention

In the above described prior gear transmission apparatus, space in an axial direction is generated between the pinions of the couple of the planetary gear mechanism or the carriers, and lubrication oil enters the space in no small measure. However, since an outer circumference of the space is covered with the commonly shared gear, so that no discharge rout of the lubrication oil exists. Further, if the pinion and the carrier of at least one of the planetary gear mechanisms rotate (revolve) around the sun gear, it becomes difficult to discharge the lubrication oil from the pinion side. As a result, the lubrication oil accumulates in the space and there is a possibility to increase loss due to agitation resistance of the lubrication oil.

In view of the foregoing, one object of the present invention is to provide a gear transmission apparatus capable of prompting drainage of lubrication oil to restrain loss due to agitation resistance of the lubrication oil.

### Means to Solve the Problems

According to the first aspect of the present invention, there is provided a gear transmission apparatus which comprises a shred gear in which two rows of internal teeth are formed on an inner circumference of a common gear main body so as to be adjacent to each other in an axial direction, wherein the internal teeth of each of the rows are meshed with an external gear to configure a transmission mechanism for each of the rows, and wherein, on condition that a rotation direction in which a frequency in use of the shared gear is high is referred to as a normal rotation direction, the internal teeth of each of the rows are inclined with respect to the axial direction such that each of inner end portions thereof in the axial direction is further deviated to the normal rotation direction than each of outer end portions in the axial direction.

In the gear transmission apparatus according to the first aspect, when the shared gear rotates in the normal rotation direction, the inclined internal teeth make the lubrication oil discharge from an inner side in the axial direction to an outer side. In this way, the lubrication oil is prevented from entering the space between the transmission mechanisms formed in the shared gear. Furthermore, even in a case where the lubrication oil enters the space between the transmission mechanisms, it is possible to prompt drainage of the lubrication oil from the space utilizing a flow of the lubrication oil to be generated by the inclinations of the internal teeth. Thus, it is possible to prevent the lubrication oil from accumulating in the space between the transmission mechanisms to thereby restrain the loss due to the agitation resistance of the lubrication oil.

In one embodiment of the present invention, the shared gear may be provided with an oil drainage hole penetrating the shared gear from an inner circumference surface existing between the adjacent two rows of the internal teeth. By providing the oil drainage hole, it is possible to discharge the lubrication oil entering the space between the transmission mechanisms through the oil drainage hole to the outer periphery of the shared gear utilizing centrifugal force.

The oil drainage hole may be inclined with respect to a radial direction of the shared gear such that an end portion on an inner circumference side thereof is further deviated to the normal rotation direction than an outer end portion on an outer circumference side thereof. As such inclination is given to the oil drainage hole, it is possible to accord a direction of the oil drainage hole and a direction of the centrifugal force operating on the lubrication oil with each other, thereby discharging the lubrication oil more efficiently.

In a case where external teeth are further formed on an outer circumference of the shared gear, the oil drainage hole may be opened on or adjacent to a position of the row of the external teeth. In this case, the lubrication oil discharged through the oil drainage hole can be used for lubrication of the external teeth of the shared gear.

According to the second aspect of the present invention, there is provided a gear transmission apparatus which comprises a shred gear in which two rows of internal teeth are formed on an inner circumference of a common gear main body so as to be adjacent to each other in an axial direction, wherein the internal teeth of each of the rows are meshed with an external gear to configure a transmission mechanism for each of the rows, and wherein the shared gear is provided with an oil drainage hole penetrating the shared gear from an inner circumference surface existing between the adjacent two rows of the internal teeth.

In the gear transmission apparatus according to the second aspect, it is possible to discharge the lubrication oil entering the space between the transmission mechanisms through the oil drainage hole to the outer periphery of the shared gear utilizing centrifugal force. Incidentally, in the gear transmission apparatus according to the second aspect, if a rotation direction in which a frequency in use of the shared gear is high may be referred to as a normal rotation direction, the oil drainage hole may be inclined with respect to a radial direction of the shared gear such that an end portion on an inner circumference side thereof is further deviated to the normal rotation direction than an outer end portion on an outer circumference side thereof. Furthermore, if a row of external teeth is further formed on an outer circumference of the shared gear, the oil drainage hole may be opened on the row of the external teeth.

Further, in one embodiment of the gear transmission apparatus according to the present invention, oil drainage grooves extending over entire length in a tooth width direction may be provided on at least either bottom lands of the shared gear or bottom lands of the external gear of the transmission mechanism. According to this embodiment, even at a position where an external gear is meshed with the internal teeth, it is possible to discharge the lubrication oil from the space between the transmission mechanisms to the outer side of the shared gear in the axial direction through the oil drainage grooves. Therefore, it is possible to discharge the lubrication oil more efficiently, thereby further restraining the loss due to the agitation resistance of the lubrication oil.

### EFFECTS OF THE INVENTION

As described above, according to the gear transmission apparatus of the present invention, the internal teeth are inclined and the lubrication oil supplied to the internal teeth is caused to generate flow in a direction of being discharged to the outside in the axial direction. Otherwise, the oil drainage hole is provided on the shared gear so that the lubrication oil can be discharged from the transmission mechanisms due to centrifugal force. Therefore, it is possible to prevent the accumulation of the lubrication oil into the space between the transmission mechanisms, to thereby restrain the loss due to the agitation resistance of the lubrication oil.

### BRIEF DESCRIPTION OF THE DRAWINGS

FIG. 1 is a view showing a main part of a power transmission mechanism of a vehicle, to which a gear transmission apparatus according to one embodiment of the present invention is applied.

FIG. 2 is a development view of an inner circumference surface of the shared gear.

FIG. 3 is a partially enlarged view of a portion at which the internal teeth of the shared gear and the external teeth of the pinion are meshed with each other.

FIG. 4 is a cross sectional view of the shared gear taken along the line IV-IV in FIG. 1.

### BEST MODE FOR CARRYING OUT THE INVENTION

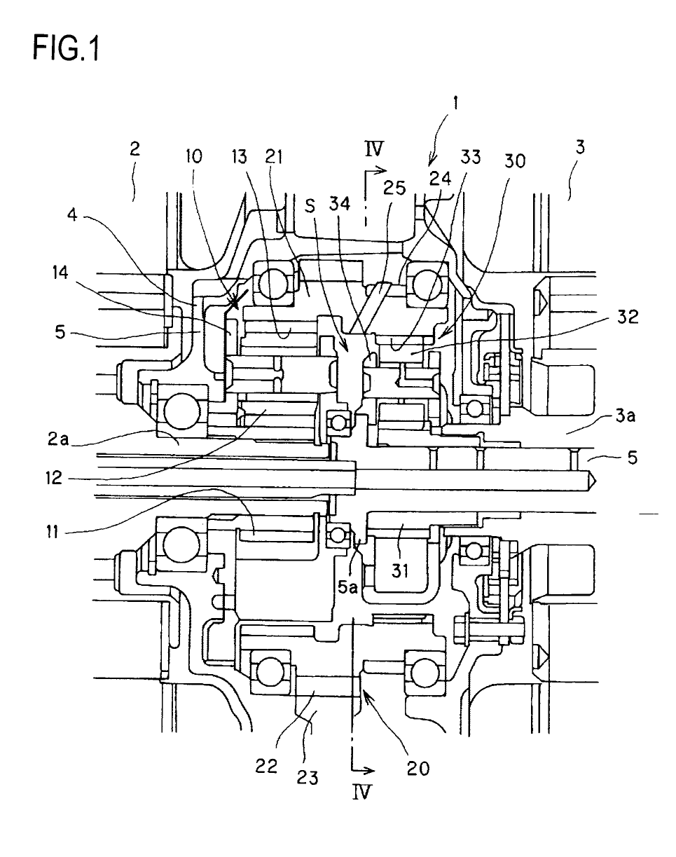

FIG. 1 shows a main part of a power transmission mechanism for a vehicle to which a gear transmission apparatus according to an embodiment of the present invention is applied. The power transmission mechanism 1 is provided with a motor speed reduction mechanism 10 which reduces rotation speed of an electric motor 2, that is a traveling drive source to be mounted on the vehicle, to output power to a driving wheel side, and a power split mechanism 30 which splits power generated by an internal combustion engine (not shown) to output the power to driving wheels and a generator 3.

The motor speed reduction mechanism 10 is configured as a planetary gear mechanism provided with a sun gear 11 which is fitted on an outer circumference of a tip end on an output shaft 2a of the motor 2 so as to be rotatable therewith, pinions 12 which is disposed on a periphery of the sun gear 11 at even intervals, a ring gear 13 which meshes with the pinions 12, a carrier 14 which holds the pinions 12. The carrier 14 is fixed on a case 4 of the power transmission mechanism 1. Accordingly, in the motor speed reduction mechanism 10, the pinions 12 merely rotate on there own axes at positions where they are held by the carrier 14 and they do not revolve around the sun gear 11.

On the other hand, the power split mechanism 30 is configured as a planetary gear mechanism provided with a sun gear 31 which is fitted on an outer circumference of one end portion on an input shaft 5 so as to be relatively rotatable to the input shaft 5, pinion 32 which are disposed on a periphery of the sun gear 31 at even intervals, a ring gear 33 which meshes with the pinions 32, a carrier 34 which holds the pinions 32. The input shaft 5 is disposed coaxially with the output shaft 2a of the motor 2. The input shaft 5 is connected with a crankshaft of the internal combustion engine through a non-shown connection mechanism, and in this way, the rotation of the crankshaft of the internal combustion engine is inputted to the input shaft 5. The input shaft 5 is provided with a flange 5a on its tip end, and the flange 5a is fixed on the carrier 34. Accordingly, the pinions 32 are driven by the input shaft 5 so as to revolve around the sun gear 31. The sun gear 31 is connected with a drive shaft 3a of the generator 3 so as to be integrally rotatable with the drive shaft 3a of the generator 3.

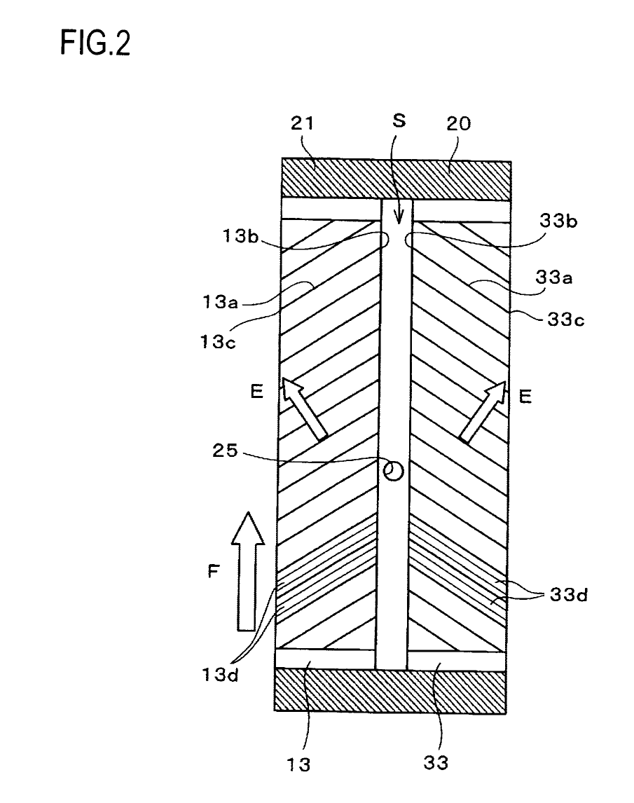

The ring gear 13 of the motor speed reduction mechanism 10 and the ring gear 33 of the power split mechanism 30 are integrated with each other to serve as portions of a shared gear 20. In other words, the shared gear 20 has a ring-shaped gear main body 21, and two rows of internal teeth 13a and 33a (see FIG. 2) which are adjacent to each other in an axial direction are formed on an inner circumference of the gear main body 21, to thereby integrate the ring gear 13 and the ring gear 33 into a united body. On an outer circumference of the shred gear 20, there is integrally formed a counter drive gear 22. The counter drive gear 22 is meshed with a counter driven gear 23. The counter driven gear 23 is connected with driving wheels of the vehicle through a reduction gear train which is not shown. Incidentally, each of the rotation parts provided in the power transmission mechanism 1 are properly supported by a bearing, but detailed description thereof will be omitted.

In the above power transmission mechanism 1, when the output shaft 2a of the motor 2 is rotated, the shared gear 20 rotates at a speed to be determined by rotation speed of the motor 2 and a gear ratio of the motor speed reduction mechanism 10, and then the rotation of the shared gear 20 is transmitted from the counter drive gear 22 to the counter driven gear 23 to allow the rotation to be output to the driving wheel side. On the side of the power split mechanism 30, the sun gear 31 rotates at speed corresponding to rotation speed of the shared gear 20 and driving speed of the input shaft 5 due to the internal combustion engine, and then the generator 3 is driven to generate electricity due to the rotation of the sun gear 31. By varying combination of the rotation speed of the motor 2 and the driving speed of the input shaft 5 due to the internal combustion engine, it is possible to drive the drive shaft 3a at appropriate speed or to stop the drive shaft 3a.

In the above power transmission mechanism 1, there is a space S between the carrier 14 of the motor speed reduction mechanism 10 and the carrier 34 of the power split mechanism 30, and the lubrication oil supplied to each of the mechanisms 10 and 30 enters the space S in no small measure. The space S is covered with the shared gear 20 from outside thereof. Furthermore, when the pinions 32 and the carrier 34 of the power split mechanism 30 rotate around the sun gear 31, it becomes difficult for the lubrication oil to be discharged from a gap between the sun gear 31 and the ring gear 33 of the power split mechanism 30. Accordingly, if any drainage routes of the lubrication oil are not secured, the lubrication oil accumulates in the space S and an agitation resistance thereto may cause an increase of loss of the power transmission. Hence, following measures are taken for the power transmission mechanism 1.

FIG. 2 is a cross-sectional view of the shared gear 20 taken along the axial direction thereof and an arrow F in the figure indicates the rotation direction of the shared gear 20 when the vehicle moves forward. When the vehicle moves backward, the shared gear 20 rotates in a reverse direction, a rotation direction with high frequency of use of the shared gear 20 is undoubtedly considered as the rotation direction at the time when the vehicle moves forward. Accordingly, hereinafter, the rotation direction of the shared gear 20 at the time when the vehicle moves forward is referred to as a normal rotation direction. In addition, right and left direction in the figure corresponds to the axial direction of the shared gear 20.

As is apparent from FIG. 2, in the power transmission mechanism 1 according to the present embodiment, the internal teeth 13a and 33a of the ring gears 13 and 33 provided on the shared gear 20 are obliquely inclined with respect to the axial direction of the shared gear 20, respectively, such that inner end portions 13b and 22b in the axial direction are further deviated to the normal rotation direction of the shared gear 20 than outer end portions 13c and 33c in the axial direction. If such inclination is given to each of the internal teeth 13a and 33a, the lubrication oil supplied to the internal teeth 13a and 33a is allowed to be discharged to the outer side in the axial direction due to the internal teeth 13a and 33a when the vehicle moves forward. Accordingly, it is possible to cause the lubrication oil to generate flow toward a direction in which the lubrication oil is discharged from an interior of the shared gear 20 (a direction of an arrow E). In this way, the lubrication oil is prevented from entering the space S. By generating the flow of the lubrication oil, it is also expected to prompt drainage of the lubrication oil from the space S.

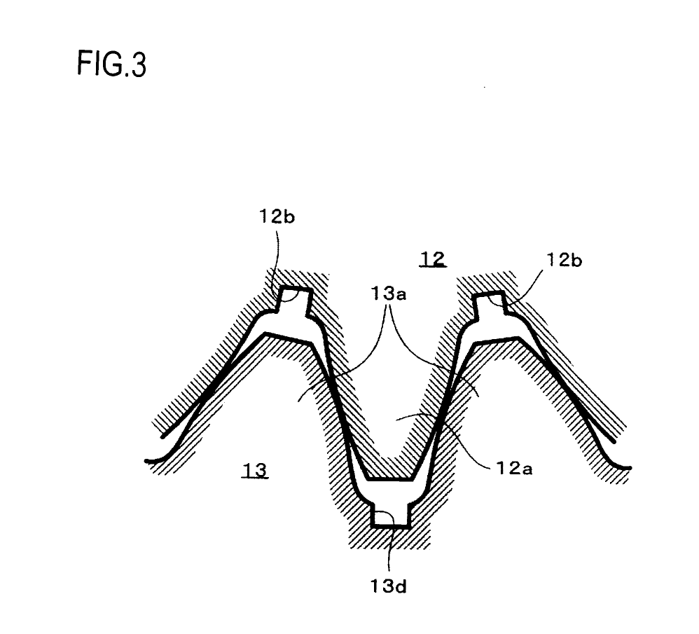

FIG. 3 is an enlarged view of a meshing portion between the external teeth 12a of one of the pinions 12 and the internal teeth 13a of the ring gear 13. As is apparent from this figure, on all bottom lands of the teeth of the pinions 12 and all bottom lands of the ring gear 13, oil drainage grooves 12b and 13d are formed, respectively. In FIG. 2, one of the oil drainage grooves 13a of the ring gears 13 is shown. The oil drainage grooves 12b extend over the entire length in a tooth width direction of the pinions 12 and the oil drainage grooves 13d extend over the entire length in a tooth width direction of the ring gears 13. Incidentally, even though a part is shown in FIG. 2, similar oil drainage grooves 33d are formed on all bottom lands of teeth of the ring gear 33. Furthermore, even though the illustration is omitted, oil drainage grooves similar to the oil drainage grooves 12b are also formed on all bottom lands of teeth of the pinions 32 to be meshed with the ring gear 33. By providing these oil drainage grooves, it is possible to secure drainage routes of the lubrication oil even at positions where the pinions 12 and 32 are meshed with the ring gears 13 and 33, respectively. Thus, it is possible to prompt drainage of the lubrication oil from the space S, thereby restraining accumulation of the lubrication oil in the space S.

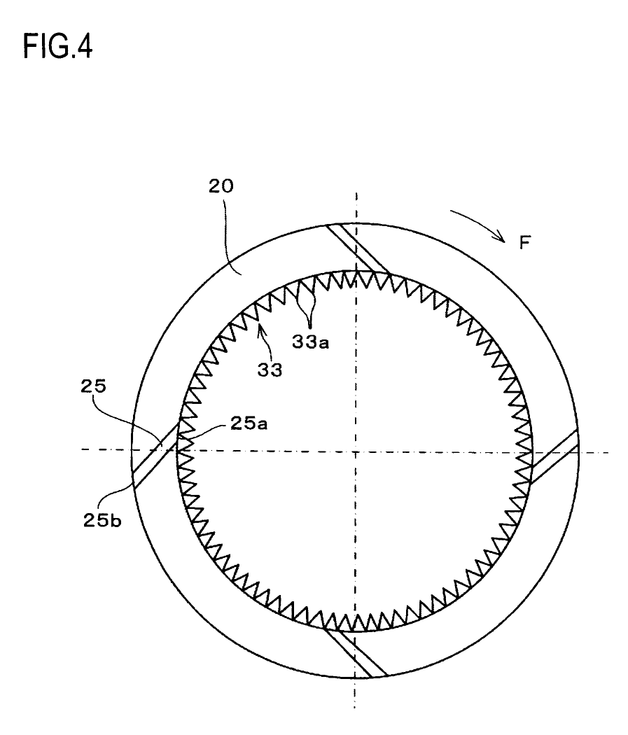

As shown in FIGS. 1, 2, and 3, the shared gear 20 is provided with oil drainage holes 25 penetrating the gear main body 21 from an inner circumference surface facing the space S to an outer circumference surface of the shared gear 20 at even intervals in the circumferential direction. As is apparent from FIG. 4, each of the oil drainage holes 25 is obliquely inclined with respect to a radial direction of the shared gear 20 such that an end portion 25a on the inner circumference side is further deviated to the normal rotation direction of the shared gear 20 than an outer end portion 25b on the outer circumference side. By providing these oil drainage holes 25, it is possible to efficiently discharge the lubrication oil entered the space S from the space S by utilizing centrifugal force. In particular, since the inclination described above is given to each of the lubrication oil drainage holes 25, it is possible to generally accord the drainage direction of the lubrication oil and the direction of the centrifugal force with each other at the time of rotating the shared gear 20 in the normal rotation direction, thereby further improving efficiency of the drainage of the lubrication oil. Incidentally, in FIG. 1, the counter drive gear 22 is positioned on an outer side in the radial direction with respect to the space S, and the oil drainage holes 25 are opened on a parking gear 24 provided adjacent to the counter drive gear 22. In this way, it is possible to utilize the lubrication oil discharged from the oil drainage holes 25 for lubrication of the counter drive gear 22 and the parking gear 24.

In the above described embodiment, each of the motor speed reduction mechanism 10 and the power split mechanism 30 corresponds to the transmission mechanism for each of the rows, and each of the pinions 12 and 32 corresponds to the external gear of the transmission mechanism. However, the present invention is not limited to the above embodiment and can be taken into practice in various embodiments. For instance, the transmission mechanism provided for each of the rows of the internal teeth on the shared gear is not limited to the planetary gear mechanism, and it can be replaced with a transmission mechanism of a proper configuration as long as it has an external gear which can be engaged with the internal teeth. The shared gear may not contain the external teeth. The oil drainage grooves may be provided on at least one of the transmission mechanisms. The oil drainage grooves may be provided on either the bottom lands of the shared gear or the bottom lands of the external gear. In this case, considering that it is enough that the oil drainage grooves exist at a meshing portion between the external gear and the shared gear, it is rather advantageous to provide the oil drainage grooves on the bottom lands of teeth of the external gear, because the number of the oil drainage grooves to be formed can be reduced with securing oil drainage function. The oil drainage hole may be one that is extended straight in the radial direction and the number thereof can be increased or decreased properly.

The gear transmission apparatus according to the present invention is not limited to an example of being provided as a part of the power transmission mechanism for the vehicle, and it can be applied to various reduction gears, accelerator gears, transmission mechanism or the like. In the present invention, it is sufficient that the shared gear is provided with two rows of the internal teeth, and even in a case where equal or to more than 3 rows of the internal teeth are provided, the present invention can be applied to two rows of the internal teeth within them.

1-8. (canceled)

9. A gear transmission apparatus comprising:
a shared gear in which two rows of internal teeth are formed on an inner circumference of a common gear main body so as to be adjacent to each other in an axial direction, the internal teeth of each of the rows being meshed with an external gear to configure a transmission mechanism for each of the rows,
wherein, on condition that a rotation direction in which a frequency in use of the shared gear is high is referred to as a normal rotation direction, the internal teeth of each of the rows are inclined with respect to the axial direction such that each of inner end portions thereof in the axial direction is further deviated to the normal rotation direction than each of outer end portions in the axial direction.

10. The gear transmission apparatus according to claim 9, wherein the shared gear is provided with an oil drainage hole penetrating the shared gear from an inner circumference surface existing between the adjacent two rows of the internal teeth.

11. The gear transmission apparatus according to claim 10, wherein the oil drainage hole is inclined with respect to a radial direction of the shared gear such that an end portion on an inner circumference side thereof is further deviated to the normal rotation direction than an outer end portion on an outer circumference side thereof.

12. The gear transmission apparatus according to claim 11, wherein a row of external teeth is further formed on an outer circumference of the shared gear, and the oil drainage hole is opened on or adjacent to a position of the row of the external teeth.

13. The gear transmission apparatus according to claim 9, wherein oil drainage grooves extending over entire length in a tooth width direction are provided on at least either bottom lands of the shared gear or bottom lands of the external gear of the transmission mechanism.

14. A gear transmission apparatus comprising:
a shared gear in which two rows of internal teeth are formed on an inner circumference of a common gear main body so as to be adjacent to each other in an axial direction, the internal teeth of each of the rows being meshed with an external gear to configure a transmission mechanism for each of the rows,
wherein the shared gear is provided with an oil drainage hole penetrating the shared gear from an inner circumference surface existing between the adjacent two rows of the internal teeth.

15. The gear transmission apparatus according to claim 14, wherein, on condition that a rotation direction in which a frequency in use of the shared gear is high is referred to as a normal rotation direction, the oil drainage hole is inclined with respect to a radial direction of the shared gear such that an end portion on an inner circumference side thereof is further deviated to the normal rotation direction than an outer end portion on an outer circumference side thereof.

16. The gear transmission apparatus according to claim 15, wherein a row of external teeth is further formed on an outer circumference of the shared gear, and the oil drainage hole is opened on the row of the external teeth.

17. The gear transmission apparatus according to claim 14, wherein oil drainage grooves extending over entire length in a tooth width direction are provided on at least either bottom lands of the shared gear or bottom lands of the external gear of the transmission mechanism.
